(19) United States
(12) Patent Application Publication
(10) Pub. No.: US 2022/0172303 A1
(43) Pub. Date: Jun. 2, 2022

(54) SOCIAL NETWORKING CONVERSATION PARTICIPANTS

(71) Applicant: INTERNATIONAL BUSINESS MACHINES CORPORATION, Armonk, NY (US)

(72) Inventors: John Handy Bosma, Leander, TX (US); Angineh AGHAKIANT, San Jose, CA (US); Christina Gray, Austin, TX (US); Shashank Ghatage, Jersey City, NJ (US)

(21) Appl. No.: 17/107,994

(22) Filed: Dec. 1, 2020

(51) Int. Cl. G06Q 50/00; H04W 4/02; H04W 4/029; H04W 4/21; G06F 21/32

(52) U.S. Cl. CPC G06Q 50/01; H04W 4/023; G06F 21/32; H04W 4/21; H04W 4/029

(57) ABSTRACT

A method, a structure, and a computer system for social networking. The exemplary embodiments may include detecting a conversation between a first user and one or more users, as well as identifying the one or more users. In addition, the exemplary embodiments include determining a location of the conversation and generating a proxy identifier corresponding to the conversation based on the location, the first user, and the one or more users. The exemplary embodiments may further include transmitting one of the proxy identifier and contact information corresponding to the first user to at least one of the one or more users.

### BACKGROUND

The exemplary embodiments relate generally to social networks, and more particularly to social networking participants to a conversation.

In leisure and business contexts, people meet in conversation but often do not exchange contact information they would later like to have. This is due to a variety of a factors, including social inhibition, the effort required to exchange information, lack of time, forgetfulness, and organizational or cultural norms. Despite these factors, establishing contacts or preserving the option to do so has very large value for a variety of enterprise use cases spanning every industry.

### SUMMARY

The exemplary embodiments disclose a method, a structure, and a computer system for location-driven network boosting. Exemplary embodiments may include detecting a conversation between a first user and one or more users, as well as identifying the one or more users. In addition, the exemplary embodiments include determining a location of the conversation and generating a proxy identifier corresponding to the conversation based on the location, the first user, and the one or more users. The exemplary embodiments may further include transmitting one of the proxy identifier and contact information corresponding to the first user to at least one of the one or more users.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a social networking system 100, in accordance with the exemplary embodiments.

FIG. 2 depicts an exemplary flowchart 200 illustrating the operations of a social networking program 134 of the social networking system 100, in accordance with the exemplary embodiments.

FIG. 3 depicts an exemplary block diagram depicting the hardware components of the social network boosting system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

This invention pertains to technology enabling verbal conversation to serve as an input to social network. We reference emerging AI technology for automated recording and transcription of verbal conversations as well as technologies in robotic process automation. The combination of these two kinds of technologies enables automation to ensure persons participating in a conversation are able to exchange contact data and established desired online social network contacts in a seamless fashion with minimal effort. This exposes significant new opportunities. For example, in leisure and business contexts, people meet in conversation but often do not exchange contact information they would later like to have. This is due to a variety of a factors, including social inhibition, the effort required to exchange information, lack of time, forgetfulness, and organizational or cultural norms. Despite these factors, establishing contacts or preserving the option to do so has very large value for a variety of enterprise use cases spanning every industry.

Our invention provides novel mechanisms to take verbal conversation and, without intervention by the user, store it as persistent records, thus enabling fully automated contact exchange, granular selection of which conversations should result in contact exchange, and extensible automation for social networking. The present invention addresses key use cases for virtually every large enterprise in every industry. This spans both business-to-business (B2B) and business-to-individual (B2I) segments critical to large enterprise business outcomes generally, and IT and tech providers in particular.

The present invention solves social networking problems of the existing art that include: 1) getting contact information for people one meets face to face is inefficient and prone to error; 2) getting contact information is often not done as people may be in a hurry, forget, or don't take the steps to share information for other reasons; 3) lack of connections inhibit the ability to form networks or follow up; 4) finding the right contact on social media is manual and prone to error (spelling mistakes, same names, etc); 5) connecting across multiple platforms is redundant exercise; and 6) social networking is not currently performed as a service targeted to multi-tenant enterprise contexts that are amenable to integration in enterprise and SaaS-type offerings that are becoming increasingly important to enterprise customers.

In practice, there are some known solutions to these problems. These solutions include explicit contact exchange, for example Wi-Fi or NFC exchange, as well as retroactive, manual lookup of the contact information afterwards. However, these solutions do not effectively address the problems listed above.

For example, neither manual nor explicit contact exchange during an interaction address any of the factors that stop people from using them (e.g., social inhibition, the effort required to exchange information, lack of time, forgetting, organizational or cultural norms, etc.). In addition, people often lack specific information so they can successful find the right person, and similarly lack the knowledge of specific steps needed in order to find that information. Moreover, technical inconsistencies among platforms inhibit the scalability of such approaches as they aren't agnostic on operating system nor provider. For example, incompatibilities between operating systems may inhibit users from utilizing a same means for sharing contact information without incorporation of custom services and overhead, all for little adoption by users. Lastly, the approaches above do not take advantage of metadata associated with a contact exchange, for example global positioning system (GPS) location, time, date, and context.

Overall, the current state of the art provides at best a mere slightly more efficient way of sharing information, yet still does not scale well because it requires people to establish connections for all platforms, and few people do. Thus approaches above are either rarely used or are only for a small percentage of potential contacts or network connections.

Advantages of the present invention include providing improved efficiency in creating social network links and contact information while implementing key principles of Privacy by Design and Privacy by Default in the use of proxy IDs, enabling pseudonymization and granular control where users and data subjects require. In addition, the present invention efficiently scales social networks without intervention or manual effort, and enables much improved retroactive findability of users with information retrieval through conversational records. Furthermore, the present invention cleanly resolves inconsistencies in devices, operating systems, over-the-air contact exchange, and other known mechanisms, and automatically supplements contact information with available metadata, per user configurable settings.

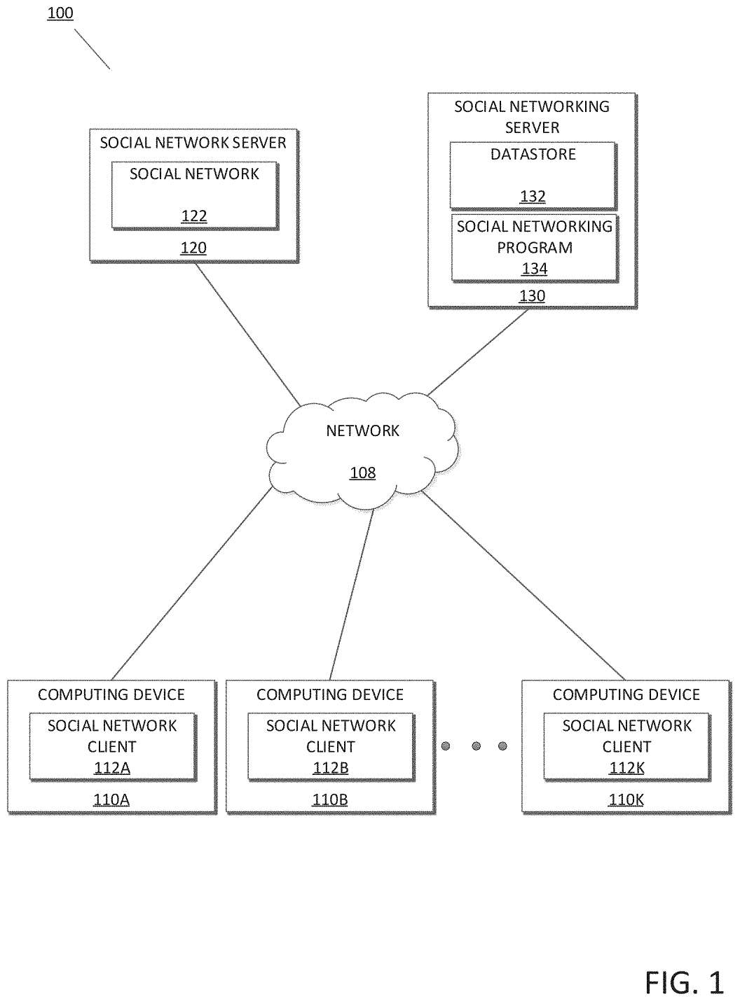

FIG. 1 depicts the social networking system 100, in accordance with exemplary embodiments. According to the exemplary embodiments, the social networking system 100 may include one or more computing devices 110A-K, a social network server 120, and a social networking server 130, which all may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted. In the following detailed description, it is assumed that there may be any number of the one or more computing devices 110A-K and each correspond to a different user of the social network 122.

In the exemplary embodiments, the network 108 may be a communication channel capable of transferring data between connected devices. The network 108 may be the Internet, representing a worldwide collection of networks and gateways to support communications between devices connected to the Internet. Moreover, the network 108 may utilize various types of connections such as wired, wireless, fiber optic, etc., which may be implemented as an intranet network, a local area network (LAN), a wide area network (WAN), or a combination thereof. In further embodiments, the network 108 may be a Bluetooth network, a Wi-Fi network, or a combination thereof. The network 108 may operate in frequencies including 2.4 GHz and 5 GHz internet, near-field communication, Z-Wave, Zigbee, etc. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

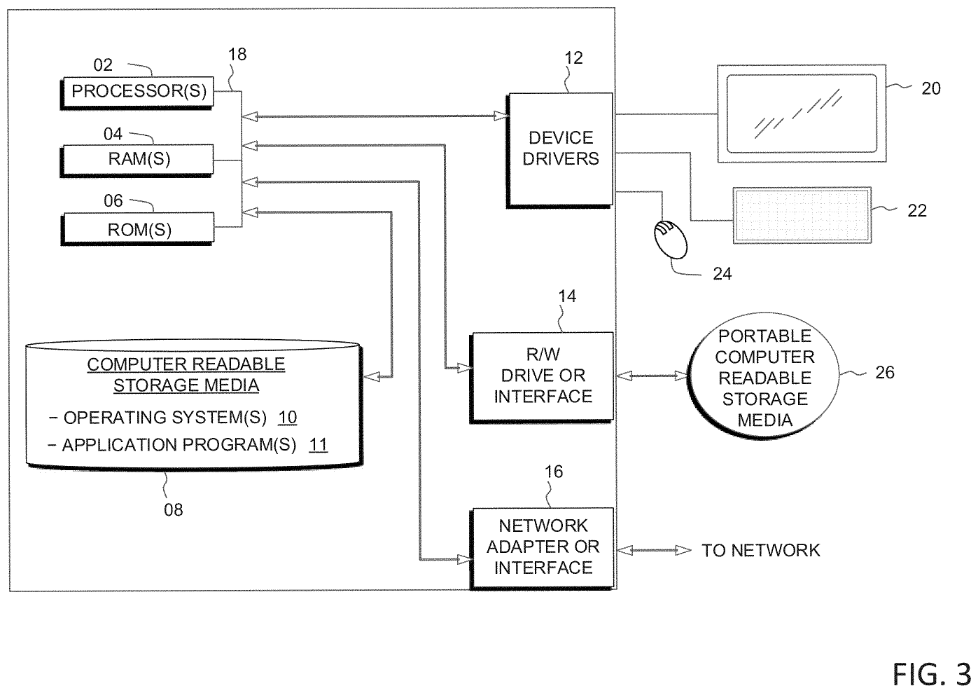

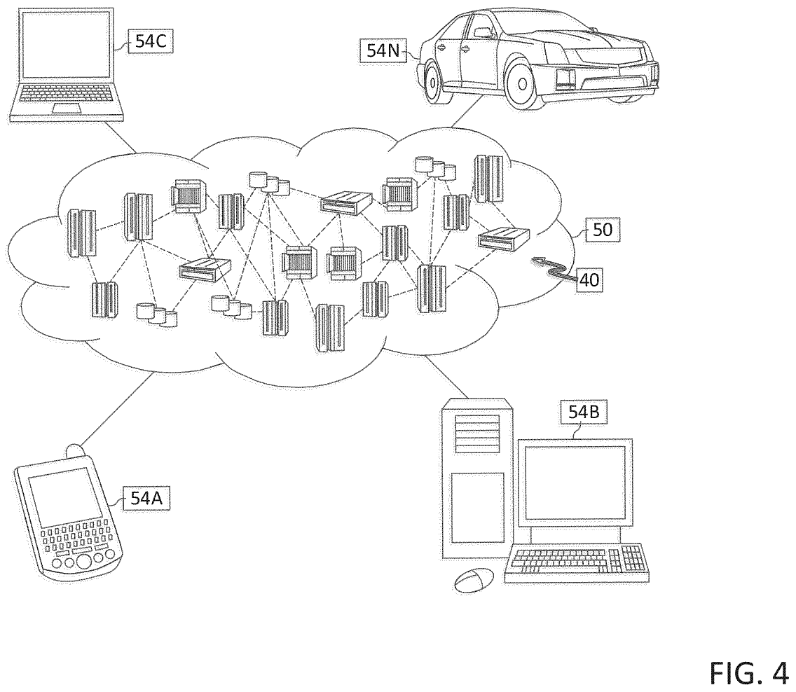

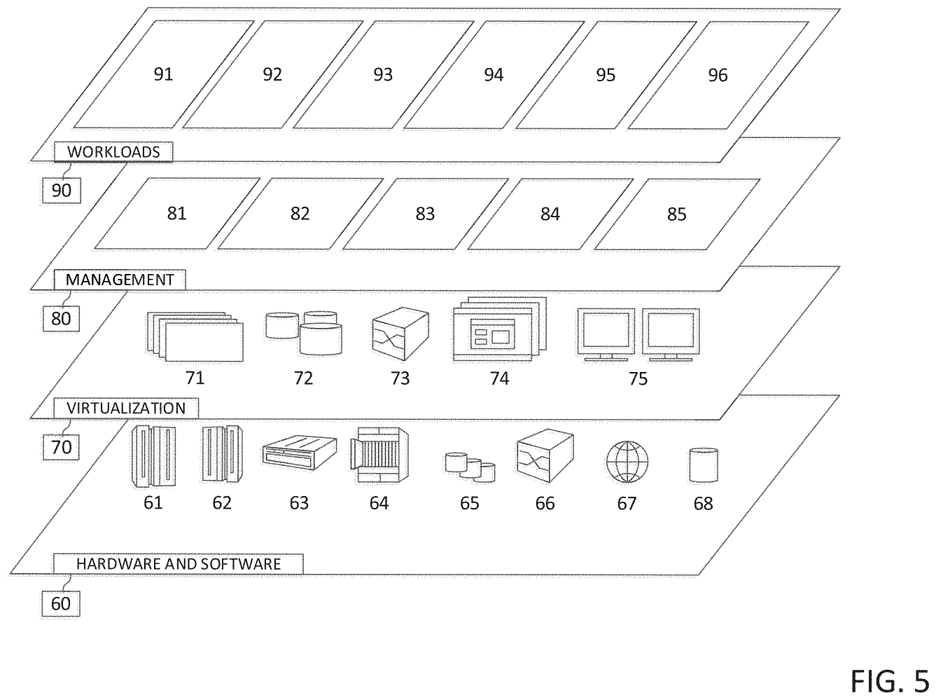

In exemplary embodiments, each of the computing devices 110A-K may include a respective social network client 112A-K, and may each be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. The computing devices 110A-K are described in greater detail as a hardware implementation with reference to FIG. 3, as part of a cloud implementation with reference to FIG. 4, and/or as utilizing functional abstraction layers for processing with reference to FIG. 5.

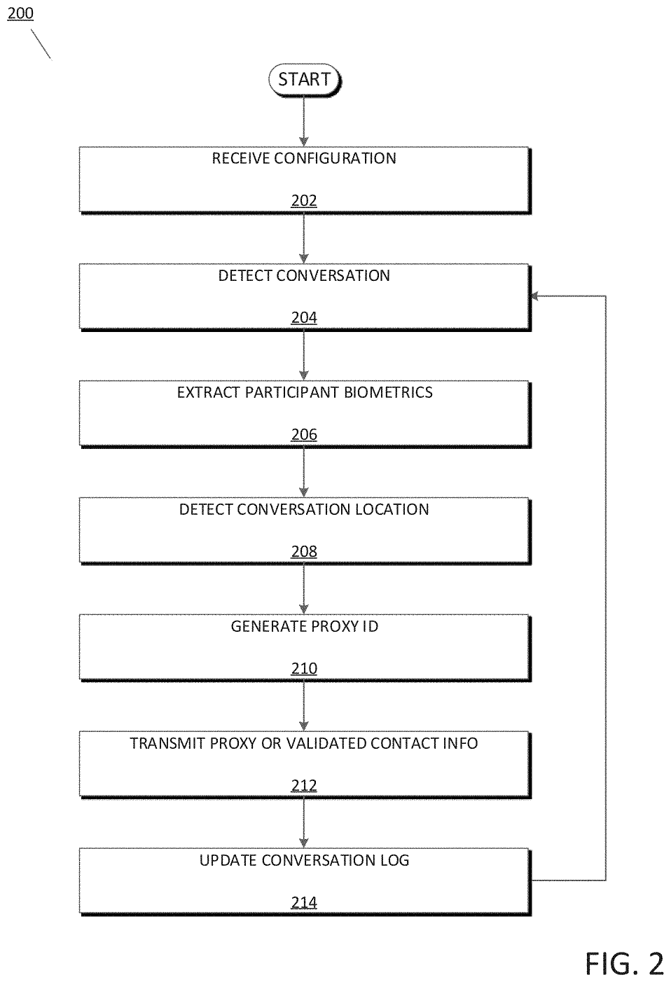

The social network clients 112A-K may act as clients in a client-server relationship with a server, e.g., the social network server 120, and may be a software and/or hardware application capable of communicating with and providing a user interface for a user to interact with a server and other computing devices via the network 108. Moreover, in the example embodiment, the social network clients 112A-K may be capable of transferring data to and from other computing devices via the network 108. In embodiments, the social network clients 112A-K may utilize various wired and wireless connection protocols for data transmission and exchange, including Bluetooth, 2.4 GHz and 5 GHz internet, near-field communication, Z-Wave, Zigbee, etc. The social network clients 112A-K are described in greater detail with respect to FIG. 2-5.

In exemplary embodiments, the social network server 120 includes a social network 122, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the social network server 120 is shown as a single device, in other embodiments, the social network server 120 may be comprised of a cluster or plurality of computing devices, in a modular manner, etc., working together or working independently. The social network server 120 is described in greater detail as a hardware implementation with reference to FIG. 3, as part of a cloud implementation with reference to FIG. 4, and/or as utilizing functional abstraction layers for processing with reference to FIG. 5.

The social network 122 may be a network for connecting one or more users. In embodiments, the social network 122 may include various means for communicating and sharing information, including a channel, inbox, text messaging, wall, activity stream, timeline, profile, etc. The social network 122 may allow users to establish relationships and networks of other users with whom the user associates, as well as seek questions to answers and local advice. The social network 122 is described in greater detail with respect to FIG. 2-5.

In exemplary embodiments, the social networking server 130 includes a datastore 132 and a social networking program 134, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the social networking server 130 is shown as a single device, in other embodiments, the social networking server 130 may be comprised of a cluster or plurality of computing devices, in a modular manner, etc., working together or working independently. The social networking server 130 is described in greater detail as a hardware implementation with reference to FIG. 3, as part of a cloud implementation with reference to FIG. 4, and/or as utilizing functional abstraction layers for processing with reference to FIG. 5.

The datastore 132 may be a database of files, folders, etc., for storing information. In embodiments, the datastore 132 may be analytical/atomic, and may detail one or more messages between one or more users of the social network 122. The datastore 132 is described in greater detail with respect to FIG. 2-5.

The social networking program 134 my a software and/or hardware program that may be capable of receiving a configuration and detecting a conversation between two or more users. In addition, the social networking program 134 may be capable of extracting biometrics from the users participating in the conversation, as well as detecting a location of the conversation. The social networking program 134 may be further capable of generating a proxy identifier corresponding to the conversation and transmitting the proxy identifier or user contact info to at least one of the users participating in the conversation based on the received configuration. Lastly, the social networking program 134 may be capable of updating conversation logs corresponding to the users. In exemplary embodiments, the social networking program 134 may be integrated with the social network 122.

FIG. 2 depicts an exemplary flowchart 200 illustrating the operations of the social networking program 134 of the social networking system 100, in accordance with the exemplary embodiments.

The social networking program 134 may receive a configuration (step 202). In embodiments, the configuration may be received via the social network clients 112A-K and the network 108, and may include receiving user account information from a user in the form of, e.g., user input, access to one or more social networks 122 via linking, integration, login (e.g., user credentials), etc. The user information may include demographic information such as name, location, address, age, embeddable electronics with unique IDs, etc., as well as user contact information such as telephone/teleconference numbers, email addresses, postal addresses, social network user accounts, handles, etc. Such contact information may be labelled by purpose (e.g., business, pleasure, government, etc.) as well as labelled based on privacy, sensitivity, etc. In embodiments, the labels for purpose and privacy may allow a user to share selective contact information on an ad hoc basis and/or configure the social networking program 134 with one or more rules to share certain contact info or a proxy representation thereof in certain circumstances. Such rules may be based on date, time, location, participants, social conversation context (activity, events, surroundings, etc.), and the like. Thus, based on the rules, the social networking program 134 may automatically transmit either the actual contact information corresponding to a user or a proxy representation thereof to participants of a conversation. Notably, the proxy is unique to the particular user with which the proxy is shared and cannot be successfully transmitted to other users, as will be described in greater detail forthcoming.

In order to better illustrate the operations of the social networking system 100, reference is now made to an illustrative example wherein a user configures the social networking program 134 to automatically share real business contact information during normal business hours and within a threshold distance of a place of business of the user (e.g., geofence). The user additionally configures the social networking program 134 to automatically share a proxy of the business information during normal business hours but outside the geofence of the place of business.

The social networking program 134 may detect a conversation (step 204). More specifically, the social networking program 134 may detect a conversation by monitoring a microphone of the computing devices 110A-K for voice stream data. The social networking program 134 may identify voice stream data based on comparing the received audio signal to average or maximum parameters of human speech in terms of frequency, amplitude, duration, etc. The social networking program 134 may further verify the audio signal as human speech based on natural language processing techniques (e.g., artificial intelligence, sentiment analysis, part of speech analysis, semantic analysis, syntactic analyses, etc.), which may identify words, phrases, parts of speech, named entities, etc. In some embodiments, and in order to additionally preserve privacy, the social networking program 134 may be configured to first listen for a wakeup command within the stream of voice data. In embodiments, the wakeup command may be words indicative of introductions, such as the word “hello” or phrase such as “nice to meet you.”

With reference again to the illustrative example introduced above, the social networking program 134 detects a wakeup command of “it's nice to meet you” within a data stream between the user and another user at lunchtime within the geofence of the user's listed place of business.

The social networking program 134 may extract one or more biometrics from users participating in the detected conversation (step 206). In embodiments, the extracted biometrics may be a voiceprint (i.e., voicegram, sonograph, etc.), which may be a record of speech analysed with respect to frequency, duration, and amplitude. For example, the voiceprint may be recorded visually using a spectrograph. In embodiments, the social networking program 134 may extract voiceprints of one or more users participating in the conversation by analysing the frequency, duration, and amplitude of one or more audio signals extracted from the detected conversation. The social networking program 134 may then compare the extracted voiceprints to known voiceprints associated with users of the social network 122 and detailed by the datastore 132 in order to identify the one or more users participating in the conversation.

If the social networking program 134 determines that the identified voiceprints are existing connections of the user, the social networking program 134 may continue to detect a conversation for a participant the user has not already connected. If the social networking program 134 is unable to match the voiceprint of a conversation participant to a known voiceprint detailed by the datastore 132, the social networking program 134 may store the user using a temporary unique identifier until a correct participant may be identified. Using the identified voiceprints, the social networking program 134 may distinguish between and identify one or more participants to the conversation. In some embodiments, the social networking program 134 may only need identify other participants to the conversation assuming that the user of the social networking program 134 has previously logged in on their respective device and thus their identity is known. Similarly, if the social networking program 134 only identifies the logged in user speaking (e.g., user reading out loud), the social networking program 134 may continue to detect audio signals until a conversation between two or more participants is identified.

Returning to the illustrative example introduced above, the social networking program 134 identifies the voiceprint of a work colleague as a participant to the detected conversation.

The social networking program 134 may detect a location of the conversation (step 208). In embodiments, the social networking program 134 may determine a location of the conversation via global positioning system (GPS) data of the one or more participants as determined by software and hardware components of the one or more smart devices 120A-K. In other embodiments, the social networking program 134 may utilize other information to identify a location of the conversation, such as check-in information, multimedia metadata, network connections (e.g., Wi-Fi, Bluetooth, NFC, etc.), landmark positions, hashtags, etc. In some embodiments, the physical location may also be dynamic, for example locations traversed by a user on a train or bus. The social networking program 134 may determine whether the location is dynamic based on the GPS data and cross-reference to schedules and/or routes of public travel. The social networking program 134 may further analyse the dynamic locations with respect to time and location to determine whether, for example, a user is on their way to work, school, the gym, etc., and classify the conversation as such.

With reference to the previously introduced example, the social networking program 134 determines a location of the conversation as a cafeteria at the place of business of the user.

The social networking program 134 may generate a proxy identifier unique to the conversation participants and location (step 210). In embodiments, the proxy identifier may be a unique identifier such as a string of characters that is a representation of the real contact information of the user. Importantly, not only is the proxy identifier irreversible to recover the real contact information, but the proxy identifier is only valid for that particular user such that it cannot be transmitted to other users effectively. In doing so, the social networking program 134 may implement key principles of Privacy by Design and Privacy by Default though the generation of proxy identifiers that enable pseudonymization and granular access control when indicated by the rules configured above. More specifically, the social networking program 134 may utilize the proxy identifier in order to transmit only portions of contact information corresponding to the users participating in the conversation, for example only business information. Thus, based on the user configured settings, the social networking program 134 generates a proxy identifier for transmission to the participants of the conversation in lieu of sending real participant contact information.

Continuing the previously introduced example, the social networking program 134 generates a proxy identifier specific to the user and co-worker and based on the location of the work cafeteria.

The social networking program 134 may transmit either the proxy identifier or validated contact information to participants of the conversation (step 212). In embodiments, the social networking program 134 distributes either the proxy identifier or the validated contact information based on the rules or by default preferences. In embodiments, for example, the default configuration may transmit a proxy by default unless otherwise specified by a user. In other embodiments, the default configuration may be to transmit the real contact information of the user. In further embodiments, the user may configure the transmission of the proxy or real contact information based on one or more rules, for example rules based on location or time. Accordingly, the social networking program 134 may reference the rules, identified participants, identified location, etc., when determining whether to transmit either the proxy identifier or real contact information to a participant to a conversation. Once determined, the social networking program 134 may share contact information across all desirable platforms of the social network 122 again based on the configuration of the user. In some embodiments where real contact information is shared by default, a user may be prompted to affirmatively confirm the transmission of real contact information prior to transmittal. In addition, a user may override the transmission of a proxy or real contact information via manual intervention.

Furthering the previously introduced example, the social networking program 134 shares the business contact information of the user with the work colleague participating in the conversation based on the rules configured to share real business contact info during business hours and within a geofence of the user's place of business. Had the conversation been outside of the geofence of the user's place of business, the social networking program 134 would transmit a proxy representation of the user's business contact information that is irreversible to decode back to the user's real business contact information and only applicable to the co-worker.

The social networking program 134 may update a conversation log (step 214). In embodiments, the social networking program 134 may maintain a log of previous conversations in order to maintain a history of communications between one or more participants to a conversation. The social networking program 134 may reference past communications to determine if users have already shared contact information as well as identify circumstances under which a proxy or real contact information is shared. For example, the social networking program 134 may train a model that correlates features such as users, locations, relationships, etc., to the decision as to whether to share real contact information or a proxy, then apply the model to new input features. The model may be, for example, a regression model.

Concluding the aforementioned example, the social networking program 134 logs the conversation and features therebetween the user and co-worker.

FIG. 3 depicts an example illustrating the operations of components of the social networking system 100, in accordance with the exemplary embodiments.

FIG. 4 depicts a block diagram of devices used within the social networking system 100 of FIG. 1, in accordance with the exemplary embodiments. It should be appreciated that FIG. 4 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a RAY drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, RAY drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfilment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and networking processing 96.

The exemplary embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for social networking, the method comprising:
detecting a conversation between a first user and one or more users;
identifying the one or more users;
determining a location of the conversation;
generating a proxy identifier corresponding to the conversation based on the location, the first user, and the one or more users; and
transmitting one of the proxy identifier and contact information corresponding to the first user to at least one of the one or more users.

2. The method of claim 1, wherein the proxy identifier is a representation of the contact information and cannot be converted back to the contact information, and wherein the proxy identifier is only operable for the at least one of the one or more users.

3. The method of claim 1, further comprising:
receiving one or more rules from the first user indicating at least one of a when and a where to share the contact information instead of the proxy identifier with the at least one user of the one or more users; and
wherein transmitting the at least one of the proxy identifier and the contact information corresponding to the first user to at least one of the one or more users is based on the one or more rules.

4. The method of claim 3, wherein the contact information is labelled based on purpose, and wherein the one or more rules further indicate the purpose to share the contact information instead of the proxy identifier.

5. The method of claim 1, wherein determining the location of the conversation is based on GPS data of a device corresponding to the first user.

6. The method of claim 1, wherein identifying the one or more users is based on biometric data.

7. The method of claim 6, wherein the biometric data is a voiceprint.

8. A computer program product for social networking, the computer program product comprising:
one or more non-transitory computer-readable storage media and program instructions stored on the one or more non-transitory computer-readable storage media capable of performing a method, the method comprising:
detecting a conversation between a first user and one or more users;
identifying the one or more users;
determining a location of the conversation;
generating a proxy identifier corresponding to the conversation based on the location, the first user, and the one or more users; and
transmitting one of the proxy identifier and contact information corresponding to the first user to at least one of the one or more users.

9. The computer program product of claim 8, wherein the proxy identifier is a representation of the contact information and cannot be converted back to the contact information, and wherein the proxy identifier is only operable for the at least one of the one or more users.

10. The computer program product of claim 8, further comprising:
receiving one or more rules from the first user indicating at least one of a when and a where to share the contact information instead of the proxy identifier with the at least one user of the one or more users; and
wherein transmitting the at least one of the proxy identifier and the contact information corresponding to the first user to at least one of the one or more users is based on the one or more rules.

11. The computer program product of claim 10, wherein the contact information is labelled based on purpose, and wherein the one or more rules further indicate the purpose to share the contact information instead of the proxy identifier.

12. The computer program product of claim 8, wherein determining the location of the conversation is based on GPS data of a device corresponding to the first user.

13. The computer program product of claim 8, wherein identifying the one or more users is based on biometric data.

14. The computer program product of claim 13, wherein the biometric data is a voiceprint.

15. A computer system for social networking, the system comprising:
one or more computer processors, one or more computer-readable storage media, and program instructions stored on the one or more of the computer-readable storage media for execution by at least one of the one or more processors capable of performing a method, the method comprising:
detecting a conversation between a first user and one or more users;
identifying the one or more users;
determining a location of the conversation;
generating a proxy identifier corresponding to the conversation based on the location, the first user, and the one or more users; and
transmitting one of the proxy identifier and contact information corresponding to the first user to at least one of the one or more users.

16. The computer system of claim 15, wherein the proxy identifier is a representation of the contact information and cannot be converted back to the contact information, and wherein the proxy identifier is only operable for the at least one of the one or more users.

17. The computer system of claim 15, further comprising:
receiving one or more rules from the first user indicating at least one of a when and a where to share the contact information instead of the proxy identifier with the at least one user of the one or more users; and
wherein transmitting the at least one of the proxy identifier and the contact information corresponding to the first user to at least one of the one or more users is based on the one or more rules.

18. The computer system of claim 17, wherein the contact information is labelled based on purpose, and wherein the one or more rules further indicate the purpose to share the contact information instead of the proxy identifier.

19. The computer system of claim 15, wherein determining the location of the conversation is based on GPS data of a device corresponding to the first user.

20. The computer system of claim 15, wherein identifying the one or more users is based on biometric data.
